(19) United States
(12) Patent Application Publication
(10) Pub. No.: US 2026/0269979 A1
(43) Pub. Date: Sep. 10, 2026

(54) LDPC OPTIMIZATION FOR SHORT-PACKET TRANSMISSION FOR NEXT-GENERATION WLAN SYSTEMS

(71) Applicant: MEDIATEK INC., Hsinchu City (TW)

(72) Inventors: Shengquan HU, San Jose, CA (US); Jianhan LIU, San Jose, CA (US); Thomas Edward PARE, Jr., San Jose, CA (US)

(21) Appl. No.: 19/167,753

(22) PCT Filed: Sep. 6, 2024
(86) PCT No.: PCT/CN2024/117573

§ 371 Date: Sep. 22, 2025

Related U.S. Application Data
(60) Provisional application No. 63/581,027, filed on Sep. 7, 2023.
(60) Provisional application No. 63/560,807, filed on Mar. 4, 2024.
(60) Provisional application No. 63/562,326, filed on Mar. 7, 2024.

(51) Int. Cl. H04L 1/00; H04L 5/00

(52) U.S. Cl. CPC H04L 1/0057; H04L 1/0003; H04L 1/0013; H04L 5/0085

(57) ABSTRACT

Techniques pertaining to low-density parity-check (LDPC) optimization for short-packet transmission for next-generation wireless local area network (WLAN) systems in wireless communications are described. An apparatus (e.g., a station (STA)) performs LDPC encoding on a plurality of bits of a short packet of less than 1000 bytes with at least one LDPC enhancement. The apparatus then transmits the short packet in a wireless communication system.

### CROSS REFERENCE TO RELATED PATENT APPLICATION

The present disclosure is part of a non-provisional patent application claiming the priority benefit of U.S. Provisional Patent Application Nos. 63/581,027, 63/560,807 and 63/562,326, filed 7 Sep. 2023, 4 Mar. 2024 and 7 Mar. 2024, respectively, the contents of which herein being incorporated by reference in their entirety.

### TECHNICAL FIELD

The present disclosure is generally related to wireless communications and, more particularly, to low-density parity-check (LDPC) optimization for short-packet transmission for next-generation wireless local area network (WLAN) systems in wireless communications.

### BACKGROUND

Unless otherwise indicated herein, approaches described in this section are not prior art to the claims listed below and are not admitted as prior art by inclusion in this section.

In wireless communications, LDPC encoding has been introduced since the Institute of Electrical and Electronics Engineers (IEEE) 802.11n specification and continues to be in use since then (e.g., as specified in the IEEE 802.11ac/ax/be standards). Since IEEE 802.11ac, pre-forward error correction (pre-FEC) padding bits has been used to align the symbol boundary, yet this approach tends to cause waster of resource and degradation in performance as compared to that under IEEE 802.11n. Some field data shows that most of the common daily Wi-Fi usage cases are with short packets with a length less than 1k bytes. For instance, most of daily Wi-Fi usage scenarios involve short packets (e.g., in the range of 200~1000 bytes of length) except for 4K video streaming and the like. Besides, over-puncturing due to pre-FEC padding tends to degrade the LDPC performance in transmission of short packets. In particular, as pre-FEC padding introduces unnecessary codewords, higher power consumption may result. Besides, a smaller number of codewords in short packets may not need post-FEC padding so as to relax the decoding latency. In view of the above, it can be seen that there is a need for a solution of LDPC optimization for short-packet transmission for next-generation WLAN systems.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to LDPC optimization for short-packet transmission for next-generation WLAN systems in wireless communications. It is believed that implementations of various schemes proposed herein may address or otherwise alleviate the aforementioned issues. For instance, implementations of various schemes proposed herein may enhance LDPC performance based on existing Wi-Fi LDPC parity check matrix(es) by utilizing one or more of the following: (1) forcing LDPC Extra Symbol Segment=1; (2) forcing the pre-FEC padding factor (or a-factor, which indicates the pre-FEC padding segment boundary)=4; (3) performing a-factor adjustment; (4) partial pre-FEC information-based encoding enhancement; and (5) modulation and coding scheme (MCS) adjustment for a given same airtime.

In one aspect, a method may involve performing LDPC encoding on a plurality of bits of a short packet of less than 1000 bytes with at least one LDPC enhancement. The method may also involve transmitting the short packet in a wireless communication system.

In another aspect, an apparatus may include a transceiver configured to communicate wirelessly and a processor coupled to the transceiver. The processor may perform LDPC encoding on a plurality of bits of a short packet of less than 1000 bytes with at least one LDPC enhancement. The processor may also transmit the short packet in a wireless communication system.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a diagram of an example scenario under a proposed scheme in accordance with the present disclosure.

FIG. 7 is a diagram of an example scenario under a proposed scheme in accordance with the present disclosure.

FIG. 8 is a diagram of an example scenario under a proposed scheme in accordance with the present disclosure.

FIG. 9 is a diagram of an example scenario under a proposed scheme in accordance with the present disclosure.

FIG. 10 is a diagram of an example scenario under a proposed scheme in accordance with the present disclosure.

FIG. 11 is a diagram of an example scenario under a proposed scheme in accordance with the present disclosure.

FIG. 12 is a diagram of an example scenario under a proposed scheme in accordance with the present disclosure.

FIG. 13 is a diagram of an example scenario under a proposed scheme in accordance with the present disclosure.

FIG. 14 is a diagram of an example scenario under a proposed scheme in accordance with the present disclosure.

FIG. 15 is a diagram of an example scenario under a proposed scheme in accordance with the present disclosure.

FIG. 16 is a diagram of an example scenario under a proposed scheme in accordance with the present disclosure.

FIG. 17 is a diagram of an example design under a proposed scheme in accordance with the present disclosure.

FIG. 18 is a diagram of an example scenario under a proposed scheme in accordance with the present disclosure.

FIG. 19 is a diagram of an example scenario under a proposed scheme in accordance with the present disclosure.

FIG. 20 is a diagram of an example scenario under a proposed scheme in accordance with the present disclosure.

FIG. 21 is a diagram of an example scenario under a proposed scheme in accordance with the present disclosure.

FIG. 22 is a diagram of an example scenario under a proposed scheme in accordance with the present disclosure.

FIG. 23 is a diagram of an example scenario under a proposed scheme in accordance with the present disclosure.

FIG. 24 is a diagram of an example design under a proposed scheme in accordance with the present disclosure.

FIG. 25 is a block diagram of an example communication system in accordance with an implementation of the present disclosure.

FIG. 26 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to LDPC optimization for short-packet transmission for next-generation WLAN systems in wireless communications. According to the present disclosure, a number of possible solutions may be implemented separately or jointly. That is, although these possible solutions may be described below separately, two or more of these possible solutions may be implemented in one combination or another.

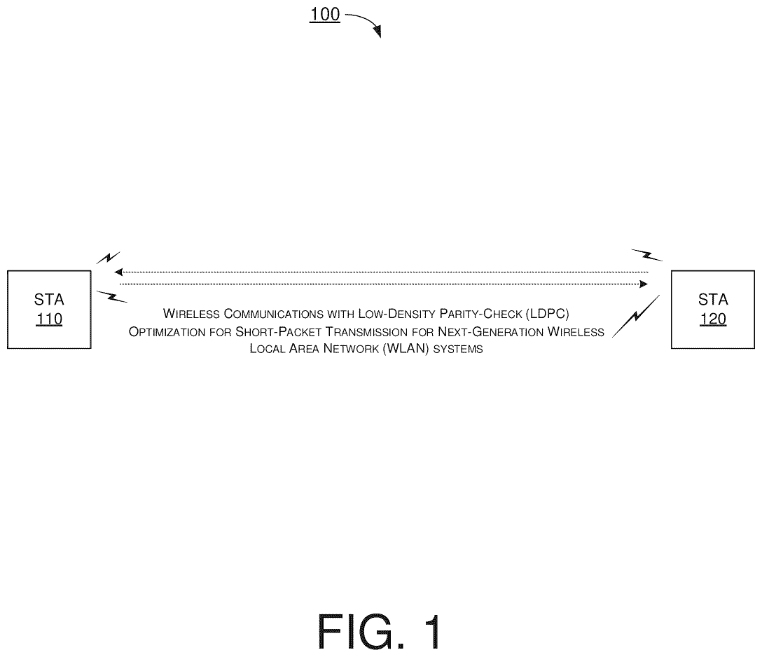

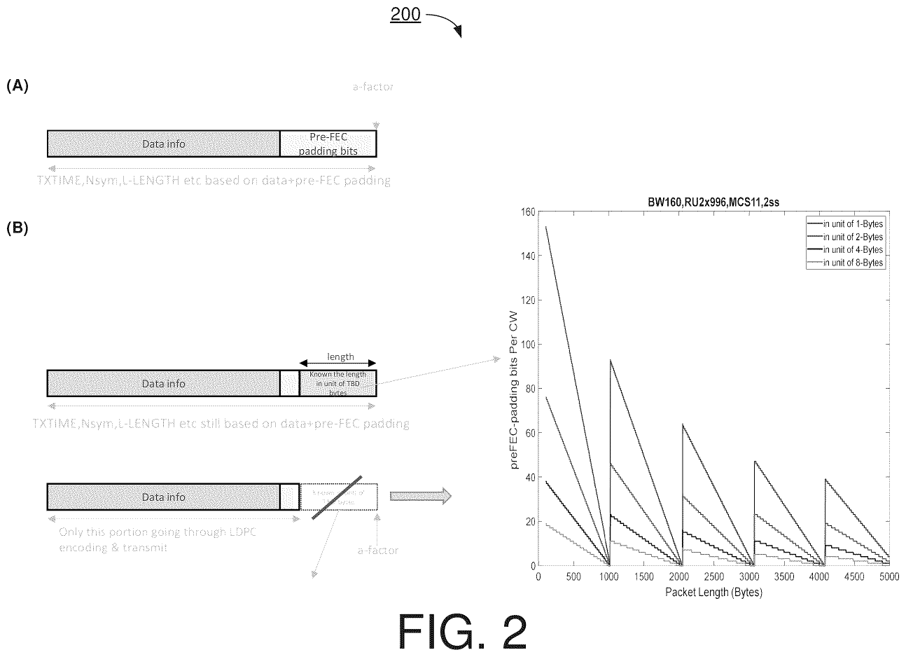

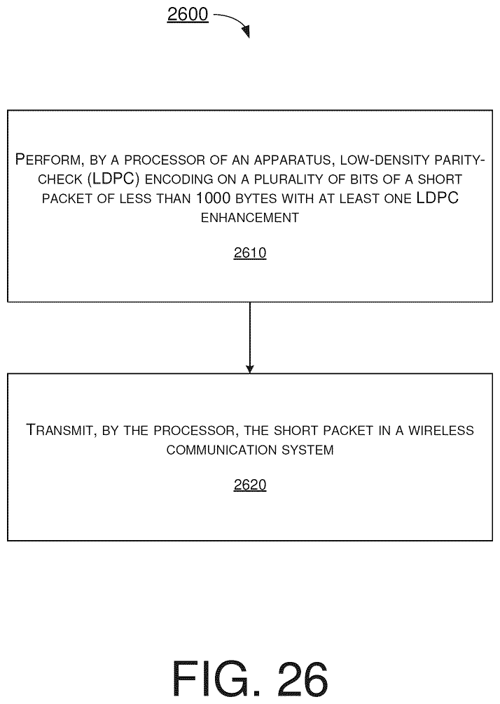

FIG. 1 illustrates an example network environment 100 in which various solutions and schemes in accordance with the present disclosure may be implemented. FIG. 2~FIG. 26 illustrate examples of implementation of various proposed schemes in network environment 100 in accordance with the present disclosure. The following description of various proposed schemes is provided with reference to FIG. 1~FIG. 26.

Referring to part (A) of FIG. 1, network environment 100 may involve at least a station (STA) 110 communicating wirelessly with a STA 120. Either of STA 110 and STA 120 may function as an access point (AP) STA or, alternatively, a non-AP STA. In some cases, STA 110 and STA 120 may be associated with a basic service set (BSS) in accordance with one or more IEEE 802.11 standards (e.g., IEEE 802.11be and future-developed standards). Each of STA 110 and STA 120 may be configured to communicate with each other by utilizing the LDPC optimization for short-packet transmission for next-generation WLAN systems in wireless communications in accordance with various proposed schemes described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Based on field data collections at the time of the present invention, >93% of laptop daily usage (e.g., email, documents and so on) is with packets of lengths in the range of 160~640 bytes, >98% of laptop online conferences are with packet of lengths in the range of 160~640 bytes; >77% of smartphone usage (except for 4K video streaming) is with packets of lengths in the range of 160~640 bytes; and >93% of smartphone 4K video streaming is with packets of lengths in the range of 1280~2560 bytes.

FIG. 2 illustrates an example scenario 200 under a proposed scheme of LDPC enhancement encoding process by using partial pre-FEC padding information in accordance with the present disclosure. Part (A) of FIG. 2 shows an example of existing encoding with both data and pre-FEC padding bits going through the encoding process. With the protocol service data unit (PSDU) length signaling, IEEE 802.11n LDPC encoding aligns orthogonal frequency-division multiplexing (OFDM) symbol boundary by repeating encoded bits. On the other hand, IEEE 802.11ac/ax/be uses pre-FEC padding to align the symbol boundary, but this tends to result in: (1) sub-optimal performance; (2) waste of resources for dummy padding bits transmission; and (3) very large number of padding bits for large resource unit (RU) size and number of spatial streams (Nₛₛ) and higher MCS (which may result in unnecessary increase in the number of codewords). Part (B) of FIG. 2 shows an example of partial pre-FEC information-based encoding under the proposed scheme. Under the proposed scheme, only data information (or a small number of pre-FEC padding bits) go through the encoding process to be transmitted. Under the proposed scheme, most of the padding bits are not physically transmitted.

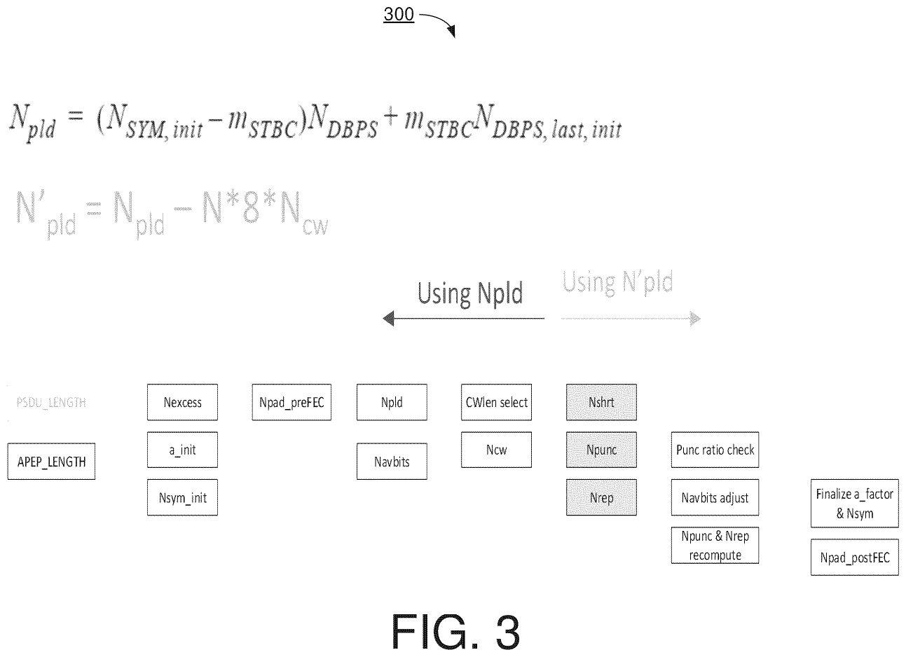

FIG. 3 illustrates an example scenario 300 under a proposed scheme of LDPC enhancement by using pre-FEC padding length information in accordance with the present disclosure. Under the proposed scheme, it may be assumed that partial pre-FEC padding bits length is known at the transmitter and the receiver so that the LDPC performance may be improved with the proposed encoding modifications. Referring to FIG. 3, with the pre-FEC padding length denoted as N bytes per codeword (CW), the number of bits in the Data field and Service field, N_{pld}, may be modified as shown in FIG. 3. N*8*Ncw pre-FEC padding bits may not go through LDPC encoding, as only the remaining N_{pad,pre-FEC}−N*8*Ncw may go through LDPC encoding (with Ncw denoting the number of codewords). All other encoding processing may remain the same as in IEEE 802.11ax/be.

Under the proposed scheme, to reduce overhead, the length of partial pre-FEC padding may be signaled in a number of bytes (e.g., 1 byte, 2 bytes, 4 bytes, 8 bytes, 16 bytes, etc). Alternatively, or additionally, a threshold may be set for the size of the number of bytes of pre-FEC padding (N_{pad,pre-FEC}) to enable the LDPC enhancement by using partial pre-FEC padding bits when N_{pad,pre-FEC}>threshold. Alternatively, or additionally, assuming the partial pre-FEC padding length is indicated in units of M-bytes, the signaling of partial pre-FEC padding in length per codeword may be derived.

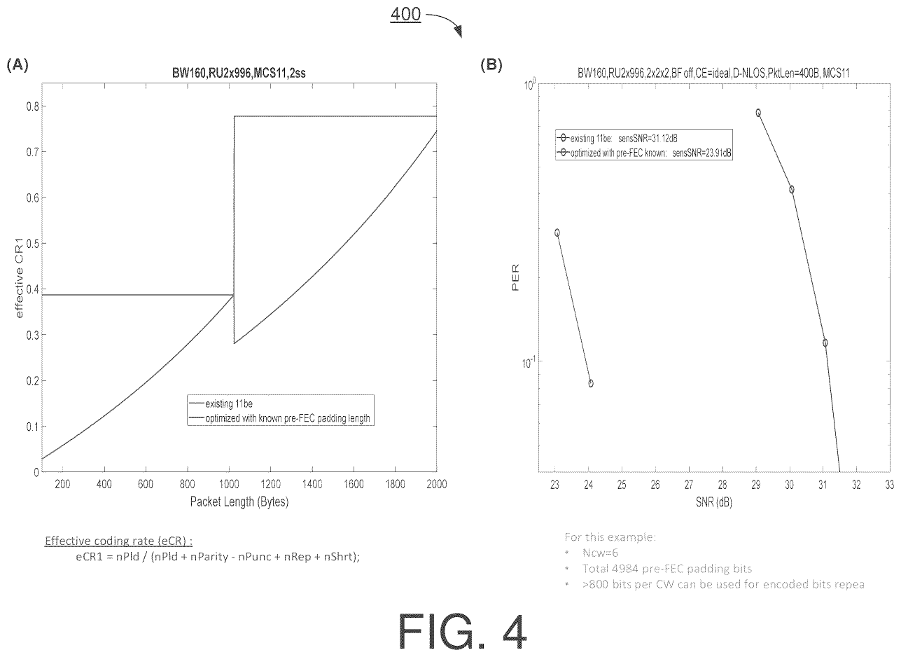

FIG. 4 illustrates an example scenario 400 of performance improvement by using pre-FEC padding length information under a proposed scheme in accordance with the present disclosure. In this simulation example, bandwidth of 160 MHz, RU(2×996), channel model D-NLOS (non-line-of-sight), ideal channel estimation (CE), MCS11, and two spatial streams (2ss) are assumed in performing transmission with the same number of symbols (N_{sym}), a-factor, power efficiency (PE) and so on to be the same as with existing IEEE 802.11be encoding. The simulation also assumes that pre-FEC padding length is known or otherwise indicated with # of TBD-bytes per codeword. Moreover, pre-FEC padding may still be “virtually” padded up to the initial a-factor, aᵢₙᵢₜ (for avoiding PSDU length signaling), but padding bits may not be physically transmitted. The original resources for transmission of padding bits may be used for either puncturing reduction or increasing repeated bits.

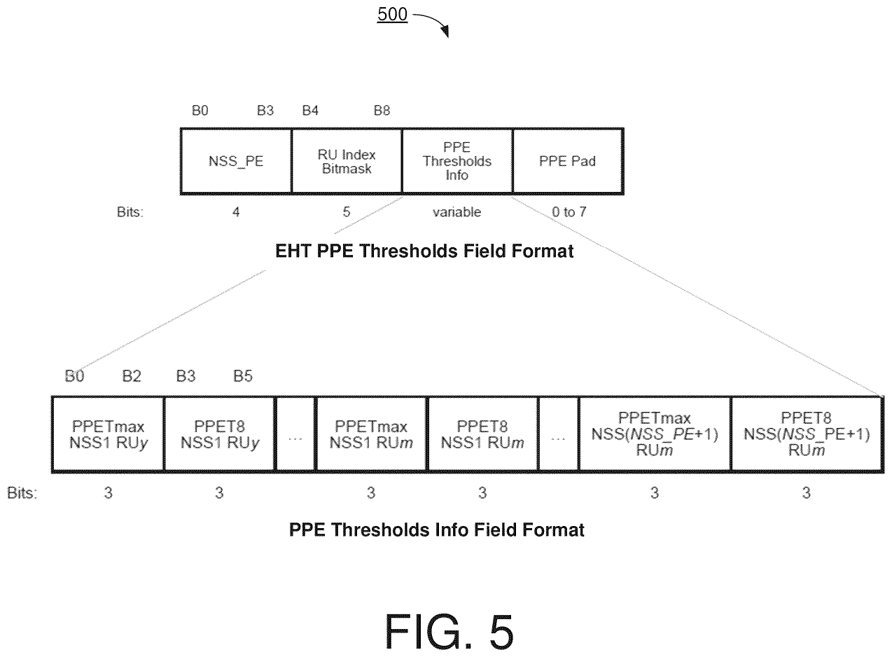

FIG. 5 illustrates an example scenario 500 of LDPC decoding capability and latency requirements under a proposed scheme in accordance with the present disclosure. In general, different vendor devices may have different LDPC decoding capabilities, and each device may claim its decoding capability in Extremely-High-Throughput (EHT) physical-layer packet extension (PPE) threshold (PPET) field. Depending on the Nₛₛ and RU size, the PPET value (PPET 8 and PPETmax for IEEE 802.11be, and PPET8 and PPET16 for IEEE 802.11ax) may be defined as constellation index (0~6 for binary phase-shift keying (BPSK)~4096 quadrature amplitude modulation (QAM)). The PPET may be only defined for RU/muti-RU (MRU) with 242 tones or more. Under the proposed scheme, the PPET definition may not be related to packet size. The nominal PE may be determined by the comparison result of PPET versus the allocated modulation/Nₛₛ/RU. The final PE may be applied according to the nominal PE and a-factor (which specifies the pre-FEC padding segment boundary). As short packets tend to have much smaller number of codewords per OFDM symbol than worst-case scenarios, under the proposed scheme, the a-factor or PE setting may be relaxed to improve LDPC performance for short packets. For instance, the value of a-factor may be forced to be always a-factor=4.

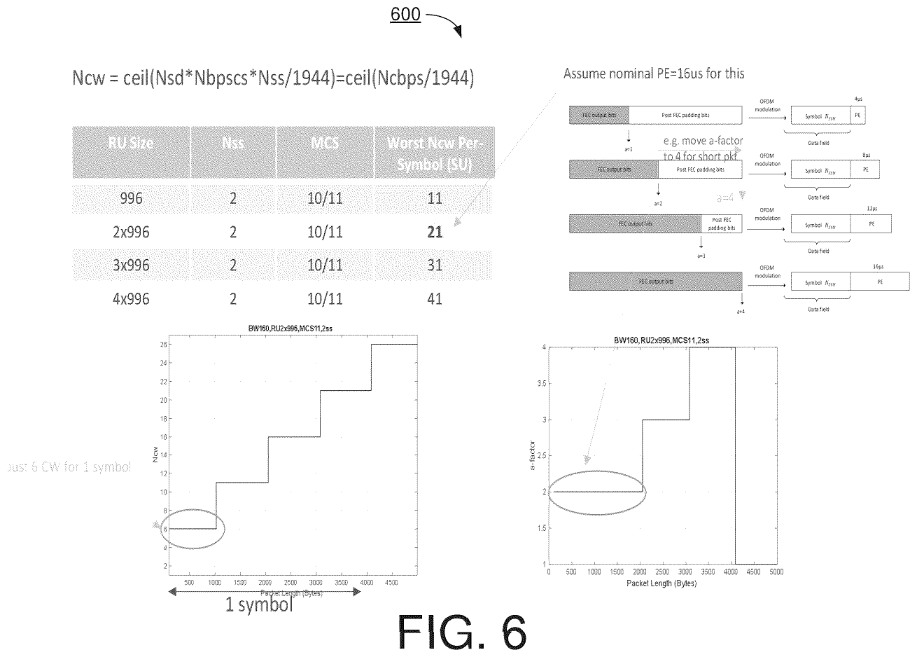

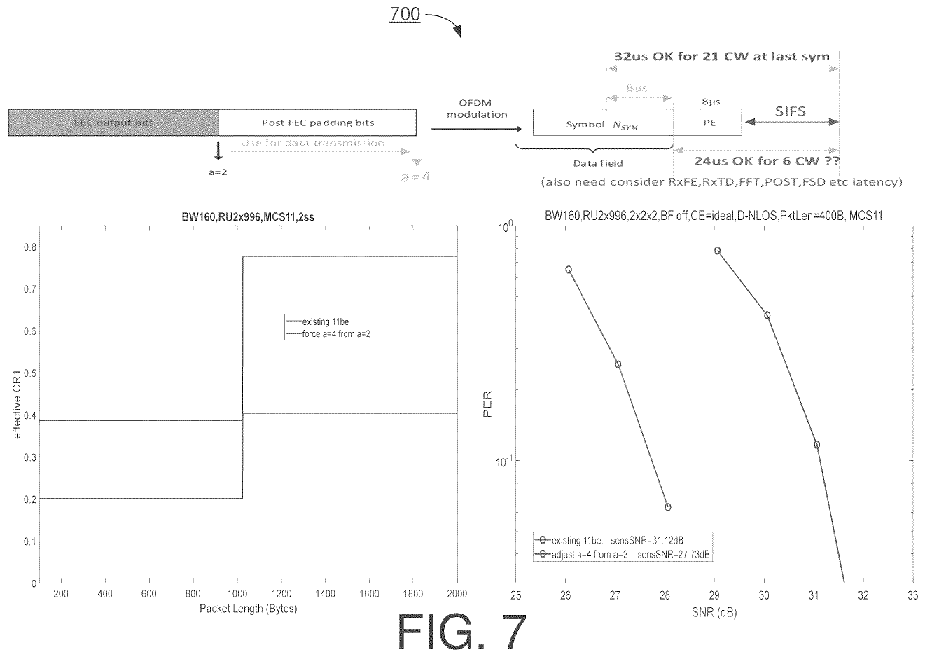

FIG. 6 illustrates an example scenario 600 of a worst case of a number of codewords (Ncw) per OFDM symbol versus a number of codewords in a short packet. FIG. 7 illustrates an example scenario 700 of performance improvement by forcing a-factor=4 under a proposed scheme in accordance with the present disclosure.

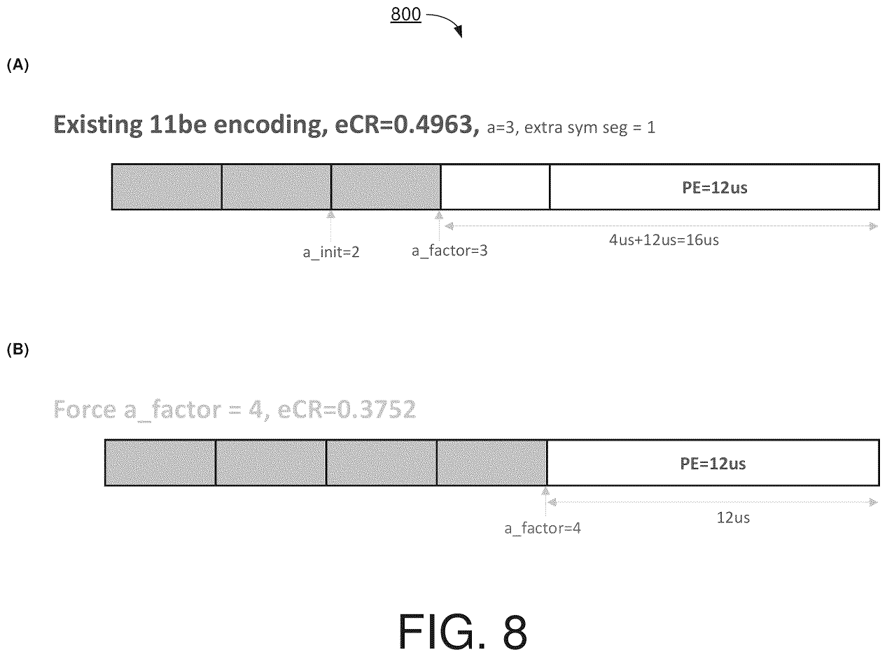

FIG. 8 illustrates an example scenario 800 of LDPC performance improvement by forcing a-factor=4 under a proposed scheme in accordance with the present disclosure. In this simulation example, bandwidth of 80 MHz, a 996-tone RU (RU996), MCS11, and one spatial stream (1ss) are assumed in performing a transmission of a 400-byte packet with N_{sym}=1 and Ncw=3. Part (A) of FIG. 8 shows an example of transmission of the 400-byte packet using an existing IEEE 802.11be encoding method with an effective coding rage (eCR)=0.4963, a=3, and extra symbol segment=1. Part (B) of FIG. 8 shows an example of transmission of the 400-byte packet by forcing a-factor=4 with eCR=0.3752.

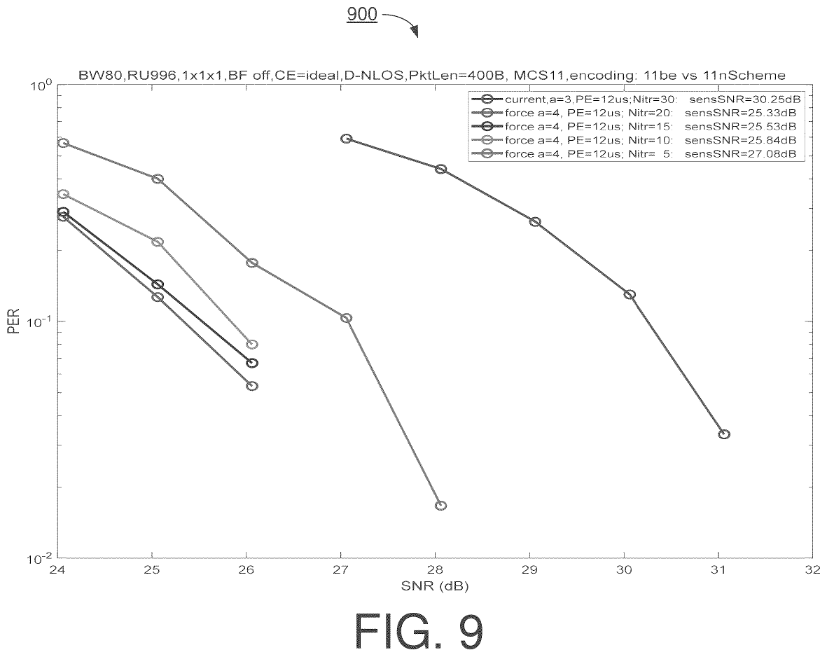

FIG. 9 illustrates an example scenario 900 of packet error rate (PER) performance with varying numbers of iterations for an LDPC decoder under a proposed scheme in accordance with the present disclosure. For this example, it may be assumed that the nominal PE=16 μs. With the parameter a (meaning the a-factor)=3, PE=12 μs, resulting in the total additional receiving (Rx) processing time=4+12=16 μs. If forcing a=4 and assuming the same airtime is kept (e.g., PE=12 μs), then the total Rx processing time=12 μs (e.g., processing time being 4 μs less due to forcing a=4). To meet the decoder latency constraint, the number of iterations may be decreased for the LDPC decoder. For instance, even by reducing to 5 iterations, a gain of >3 dB may be achieved for this example.

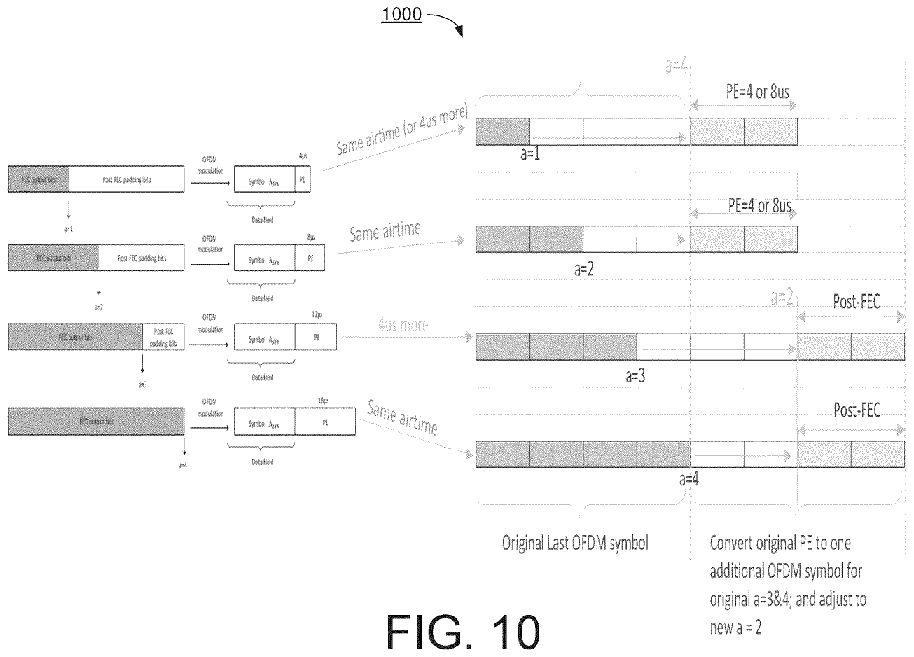

FIG. 10 illustrates an example scenario 1000 of LDPC performance enhancement by a-factor adjustment under a proposed scheme in accordance with the present disclosure. Under the proposed scheme, instead of forcing a=4 and not crossing any symbol boundary, LDPC performance may be further improved by adjusting the a-factor to result in crossing of the last symbol boundary when the initial a-factor (a_init)=3 or 4. Referring to FIG. 10, under the proposed scheme, the original packet extension (PE) may be converted to one additional OFDM symbol for the original a=3 or 4. Additionally, the a-factor may be adjusted to a new a=2.

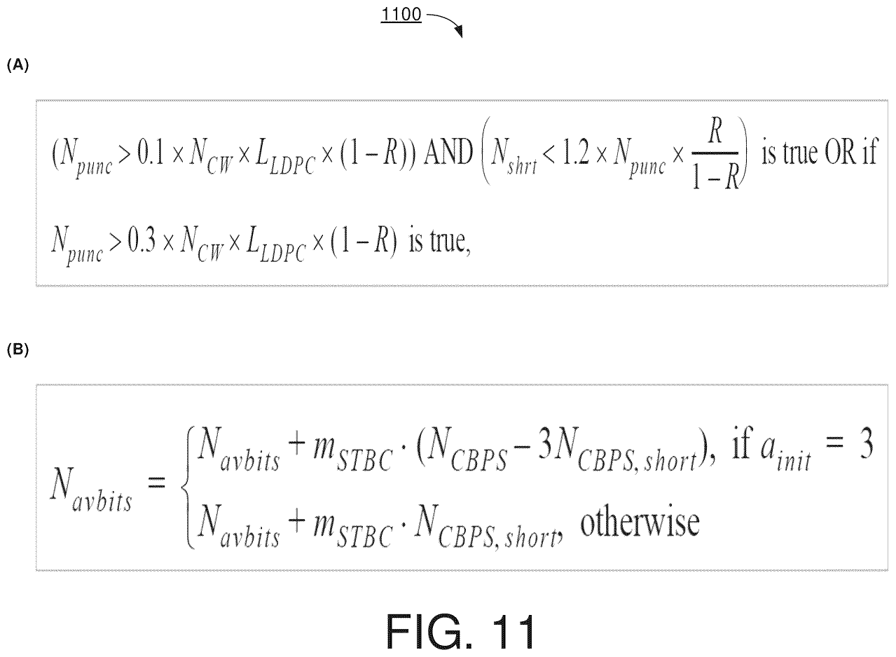

FIG. 11 illustrates an example scenario 1100 of forcing LDPC extra symbol segment=1 under a proposed scheme in accordance with the present disclosure. At the time of the present disclosure, the current rule is to set the LDPC Extra Symbol Segment field to 1 in case of the conditions shown in part (A) of FIG. 11 are met. Otherwise, the LDPC Extra Symbol Segment field may be set to 0. Under the proposed scheme, to achieve LDPC performance enhancement, the LDPC Extra Symbol Segment field may be always set to 1 so as to increase the number of available bits (N_{avbits}), as shown in part (B) of FIG. 11. Advantageously, doing so may result in either reduction in puncturing bits or increase in repeated bits.

With respect to the scheduling and MCS selection, most devices may schedule their transmissions as much as possible by using the wider bandwidth or larger-size RU if available, highest MCS if allowed by the channel condition, and/or the largest Nₛₛ. Notably, packet size may not be considered as a factor in the MCS selection or rate adaptation. The rate and/or MCS may usually be selected in advance without consideration of the packet size. Under a proposed scheme in accordance with the present disclosure, for a pre-selected MCS and a known short packet size, the MCS or other parameters (e.g., a-factor) may be optimized or refined for the same effective efficiency/physical layer (PHY) rate to render the transmission more reliable, less power consuming and/or achieving better coverage range.

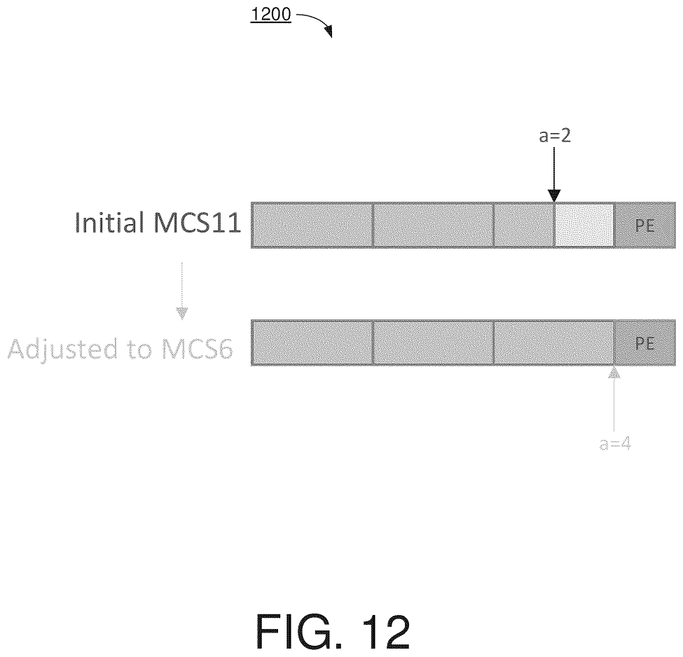

FIG. 12 illustrates an example scenario 1200 of LDPC enhancement by MCS adjustment under a proposed scheme in accordance with the present disclosure. Under the proposed scheme, given a payload size with the same airtime efficiency, system performance may be optimized by selecting a lower MCS during the LDPC encoding process. Assuming the initial MCS (MCSᵢₙᵢₜ) is pre-selected based on channel condition for a given RU size and Nₛₛ, for the same N_{sym} which is calculated using MCSᵢₙᵢₜ, a lower MCS may be chosen with even a smaller Ncw. The MCS may be adjusted to either render a=4 or keep the same a-factor with the same PE (depending on the device processing capability).

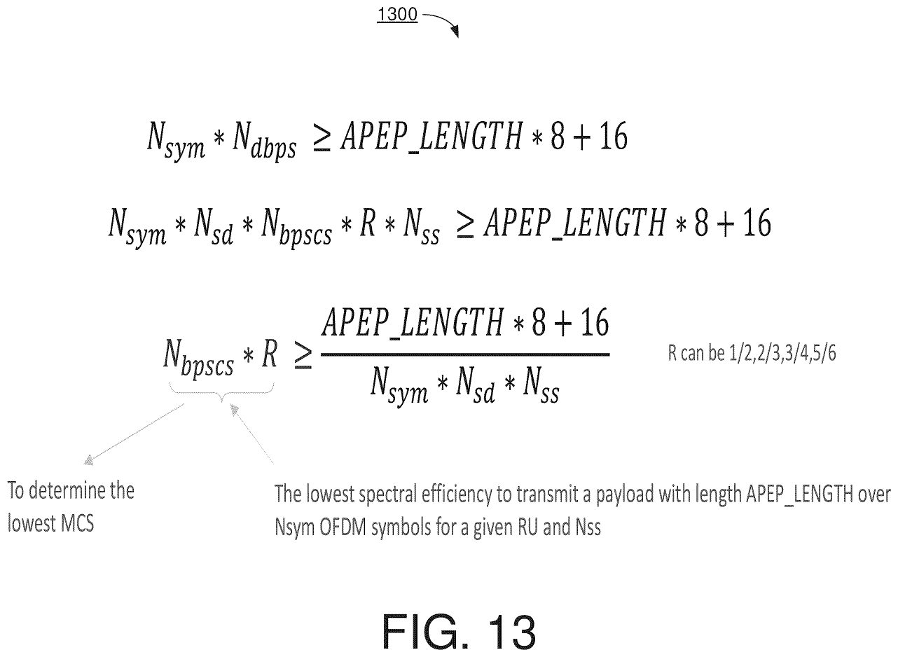

FIG. 13 illustrates an example scenario 1300 of system and LDPC performance enhancement by adjusting MCS and relaxing a-factor under a proposed scheme in accordance with the present disclosure. Under the proposed scheme, the initial scheduling may be assumed with the following assignments for a STA (e.g., STA 110 or STA 120): APEP_LENGTH, MCSᵢₙᵢₜ with coding rate Rᵢₙᵢₜ, RU size with a number of data tone-carrying subcarriers (N_{sd}), Nₛₛ, and N_{sym} being calculated from the initial MCS assignment. Then, the lowest MCS used in transmitting the same payload with the same airtime (e.g., same N_{sym}) may be derived as shown in FIG. 13.

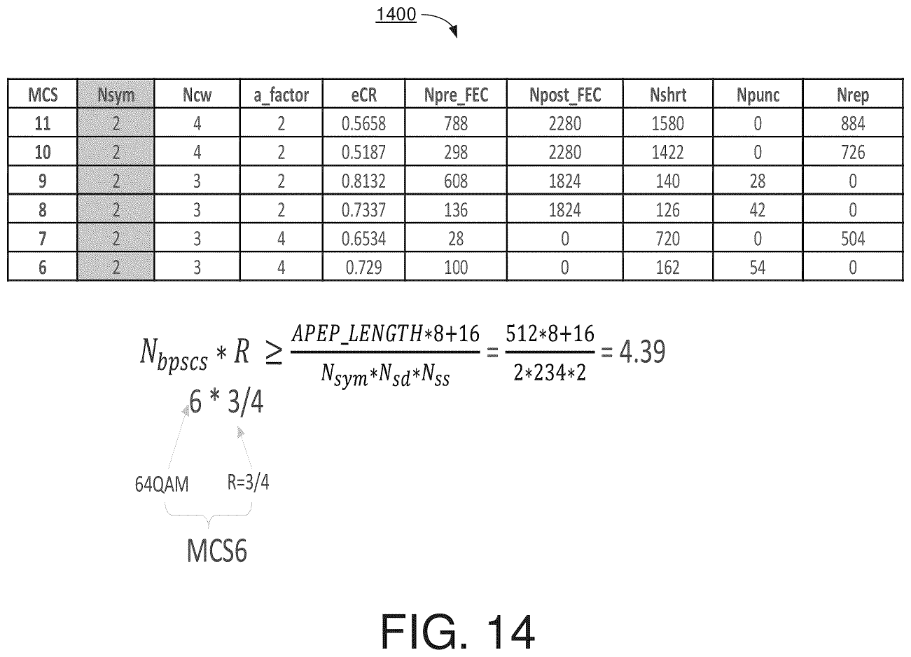

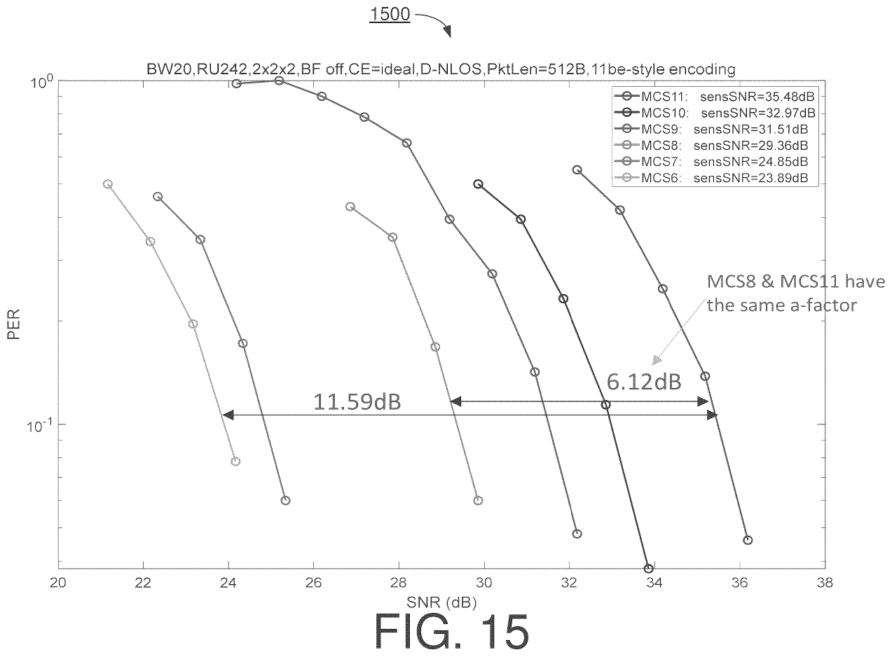

FIG. 14 illustrates an example scenario 1400 of system and LDPC performance enhancement by adjusting MCS under a proposed scheme in accordance with the present disclosure. In this simulation example, bandwidth of 20 MHz, a 242-tone RU (RU242), and Nₛₛ=2 are assumed in performing a transmission of a 512-byte packet with MCSᵢₙᵢₜ=11. FIG. 15 illustrates an example scenario 1500 of system and LDPC performance enhancement by adjusting MCS for this simulation.

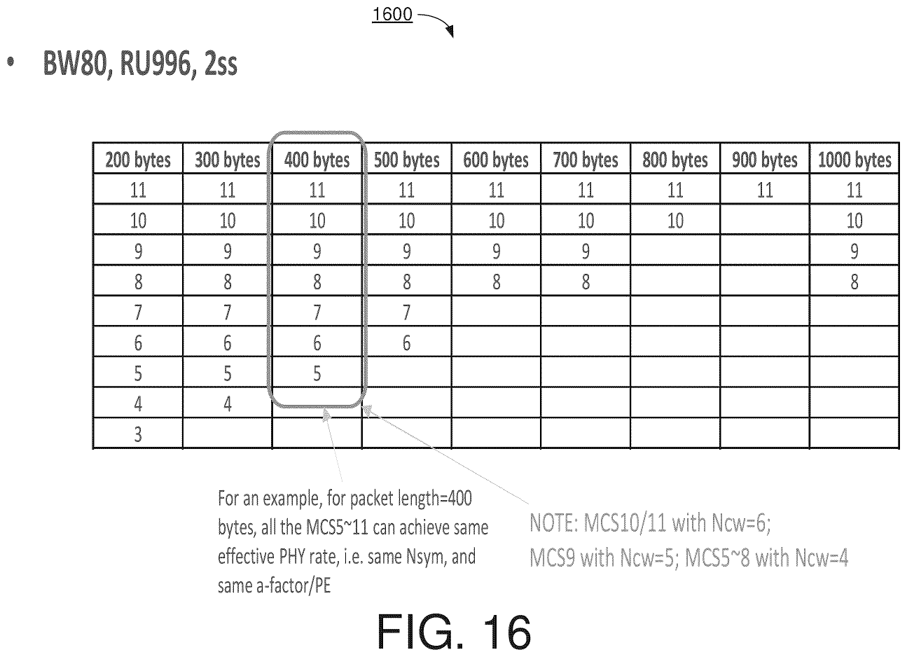

FIG. 16 illustrates an example scenario 1600 of system and LDPC performance enhancement by adjusting MCS under a proposed scheme in accordance with the present disclosure. In this simulation example, it may be assumed that MCS11 is pre-selected. Under the proposed scheme, the MCS level may be refined for different packet sizes. The table in FIG. 16 assumes that all MCS levels are with the same a-factor and same N_{sym} for a given packet size.

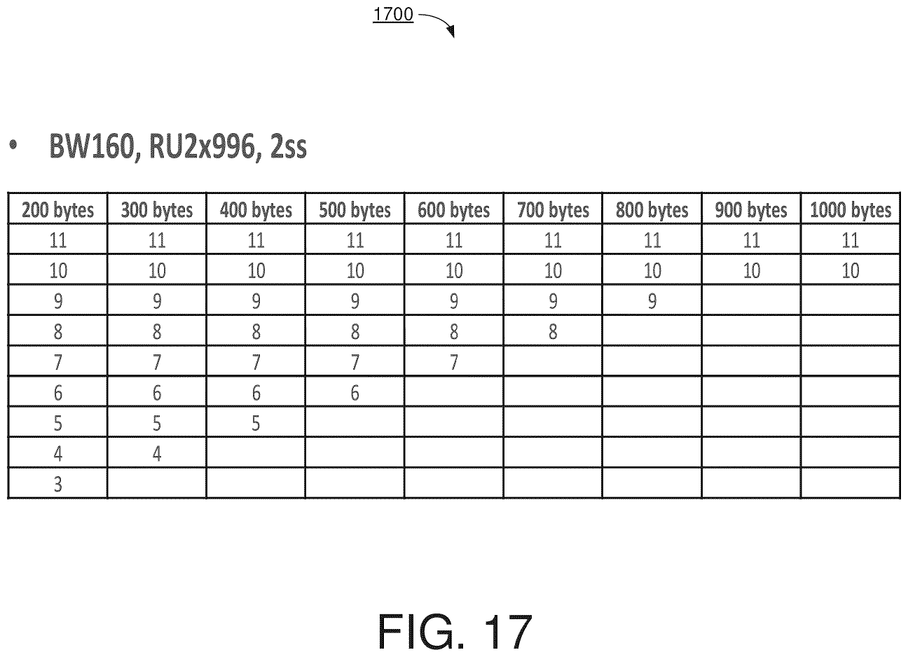

FIG. 17 illustrates an example scenario 1700 of system and LDPC performance enhancement by adjusting MCS under a proposed scheme in accordance with the present disclosure. In this simulation example, it may be assumed that MCS11 is pre-selected. Under the proposed scheme, the MCS level may be refined for different packet sizes. The table in FIG. 17 assumes that all MCS levels are with the same a-factor and same N_{sym} for a given packet size.

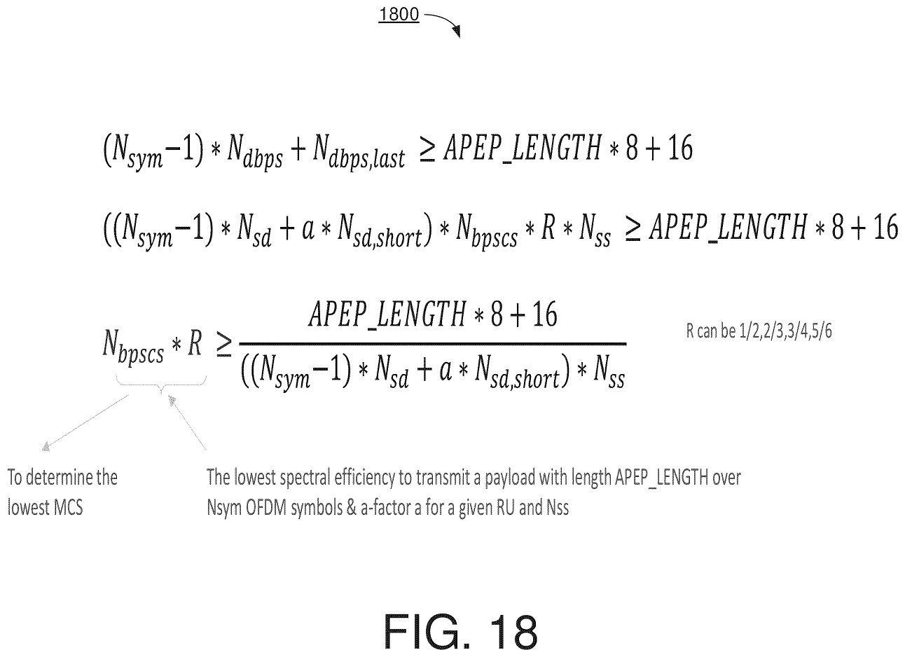

FIG. 18 illustrates an example scenario 1800 of LDPC performance enhancement by adjusting MCS and keeping the same a-factor under a proposed scheme in accordance with the present disclosure. In this simulation example, it may be assumed that the initial scheduling is with the following assignments for a STA (e.g., STA 110 or STA 120): APEP_LENGTH, MCSᵢₙᵢₜ with coding rate Rᵢₙᵢₜ, RU size with N_{sd}, Nₛₛ, and N_{sym} being calculated from the initial MCS assignment. Then, the lowest MCS used in transmitting the same payload with the same airtime (e.g., same N_{sym} and same a-factor) may be derived as shown in FIG. 18.

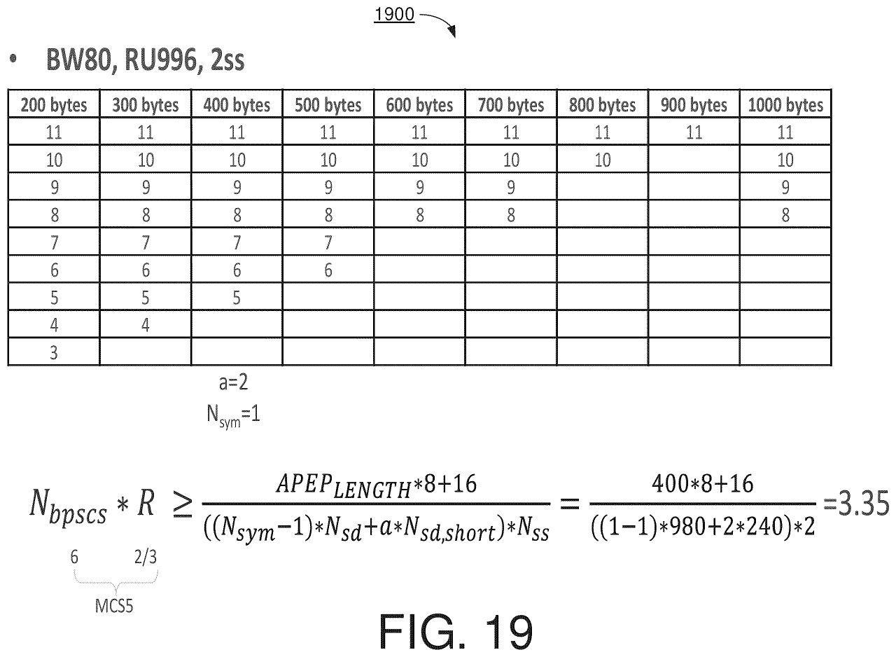

FIG. 19 illustrates an example scenario 1900 of system and LDPC performance enhancement by adjusting MCS under a proposed scheme in accordance with the present disclosure. In this simulation example, it may be assumed that MCS11 is pre-selected. Under the proposed scheme, the MCS level may be refined for different packet sizes. The table in FIG. 19 assumes that all MCS levels are with the same a-factor and same N_{sym} for a given packet size.

Under a proposed scheme in accordance with the present disclosure, LDPC performance enhancement for short packets may be achieved by lowering or otherwise decreasing the effective coding rate (eCR), which may be achieved via one or more approaches. For instance, the number of pre-FEC padding bits may be reduced. Alternatively, or additionally, the number of available bits may be increased by either adding extra symbol segments or adding extra OFDM symbols (e.g., 1 or 2 or 3 or 4 or other number of OFDM symbols). Alternatively, or additionally, the post-FEC padding portion in the IEEE 802.11ax/be may be removed, with a fixed length of packet extension portion (PE) being appended or without appending any PE. Under the proposed scheme, the target or goal of the rate matching design to enhance LDPC performance may be multi-fold and may include, for example: minimizing modification of the IEEE 802.11 standards, less impact on implementation, simpler and easier link/rate adaptation, simple signaling with less overhead, and achieving performance gains for most of the application scenarios.

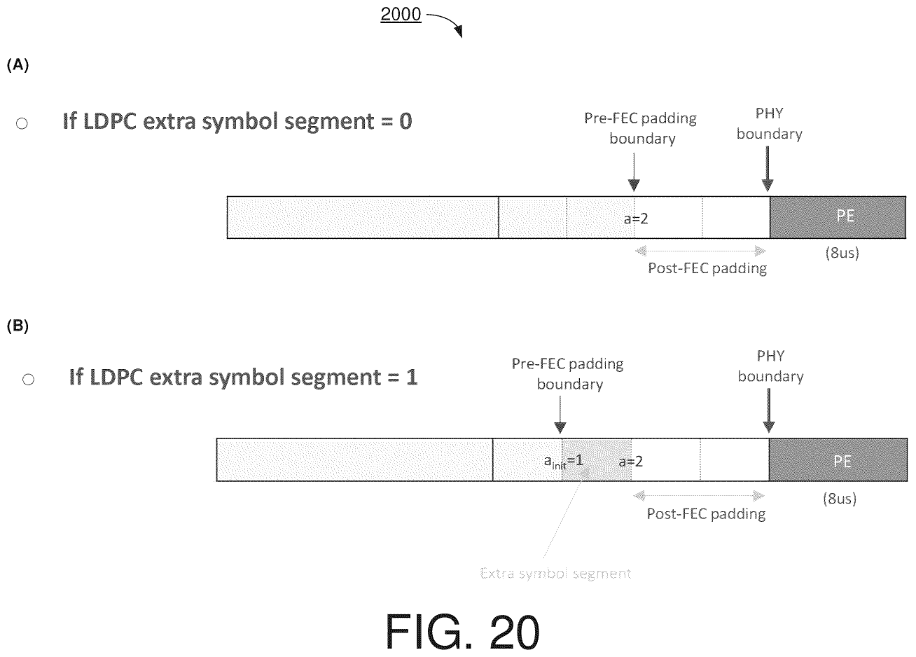

FIG. 20 illustrates an example scenario 2000 of pre-FEC padding, post-FEC padding and packet extension in IEEE 802.11ax/be. Referring to FIG. 20, in IEEE 802.11ax/be, the PHY boundary (herein interchangeably referred to as “FEC coding boundary”, “FEC encoding boundary” and/or “FEC boundary”) may be indicated by the parameter a-factor. The pre-FEC padding boundary (herein interchangeably referred to as “MAC boundary”) may be indicated by a-factor and “LDPC extra symbol segment”. The packet extension (PE) duration may be determined by a-=factor and a nominal PE value (T_{PE,nominal}). Part (A) of FIG. 20 shows an example of a=2 and T_{PE, nominal}=16 μs, if the LDPC extra symbol segment=0. Part (B) of FIG. 20 shows an example of a=2 and T_{PE,nominal}=16 μs, if the LDPC extra symbol segment=1.

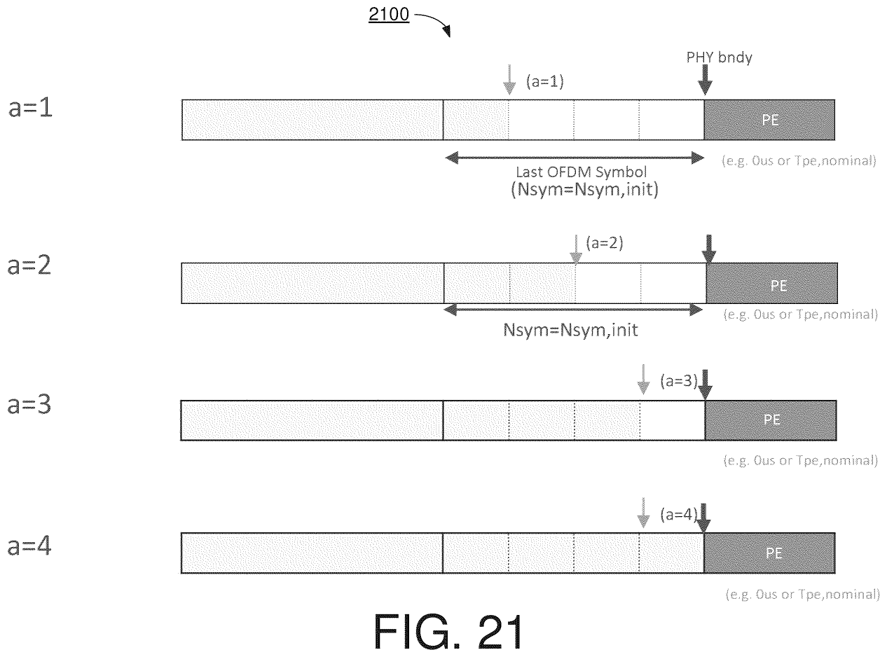

FIG. 21 illustrates an example scenario 2100 of rate matching in a first option (Option-0) under a proposed scheme in accordance with the present disclosure. Under the proposed scheme, the value of LDPC extra symbol segment may be always forced to be 1. The definitions and calculation of a-factor may be kept the same as in IEEE 802.11be. The value of a-factor may be kept to be up to 4, and the calculation of N_{sym} and initial number of symbols (N_{sym,init}) may be kept the same as in IEEE 802.11be. Also, there is no post-FEC padding under the proposed scheme. The PHY boundary (or FEC coding boundary) may be always at the end of an OFDM symbol regardless of the a-factor value. A fixed PE with the duration of T_{PE, nominal} may be independent of the a-factor. Under the proposed scheme, the meaning of “LDPC extra symbol segment” may be re-purposed to indicate the PE duration or to indicate the addition of extra symbols. For instance, a value of LDPC extra symbol segment=0 may indicate no PE or no extra OFDM symbol being added, and a value of LDPC extra symbol segment=1 may indicate that the transmission is with PE, with the PE duration being a fixed value as the nominal PE (T_{PE, nominal}) regardless of the value of the a-factor.

Referring to FIG. 21, under Option-0, the value of LDPC extra symbol segment may be always forced to 1. The pre-FEC padding boundary may be at the position of a−1. In an event that a=1, then the pre-FEC padding boundary may be at the end of the previous symbol. The PHY boundary may be always at the end of the last OFDM symbol, and there may be no post-FEC padding. The PE may be a fixed value as T_{PE, nominal}, regardless of the value of the a-factor.

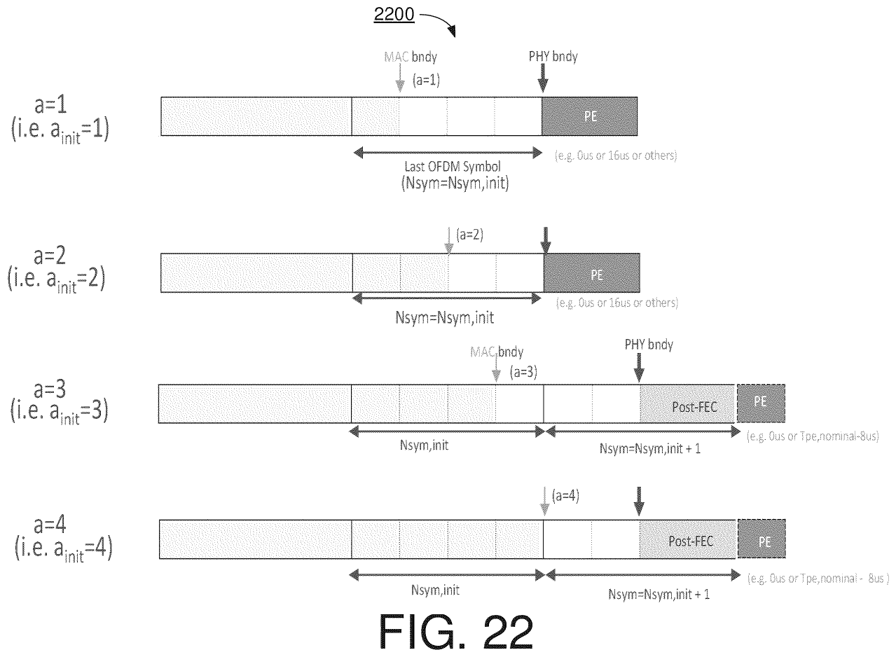

FIG. 22 illustrates an example scenario 2200 of rate matching in a second option (Option-1) under a proposed scheme in accordance with the present disclosure. Under the proposed scheme, the definition of a-factor may be re-purposed to indicate the initial a-factor (aᵢₙᵢₜ) instead of a-factor (e.g., the parameter a-factor may be used to indicate the pre-FEC padding boundary or medium access control (MAC) boundary). The value of aᵢₙᵢₜ or a-factor may be kept up to 4 (e.g., aᵢₙᵢₜ or a=1, 2, 3, 4) or other values (e.g., 1~8 or 1~16 or else). The PHY boundary or FEC coding boundary may be determined by the value of aᵢₙᵢₜ. For instance, if aᵢₙᵢₜ=1 or 2, PHY boundary may be at the end of an OFDM symbol, with no post-FEC padding; and if aᵢₙᵢₜ=3 or 4, one extra OFDM symbol may be added, and PHY boundary may be in the middle of the extra OFDM symbol, with 8 μs for post-FEC padding. Under the proposed scheme, the meaning of the parameter of LDPC extra symbol segment may be re-purposed to indicate the PE duration or to indicate the addition of extra symbol(s). For instance, LDPC extra symbol segment=0 may indicate no PE, and LDPC extra symbol segment=1 may indicate that the transmission is with PE, with the PE duration being either fixed or determined according to aᵢₙᵢₜ and nominal PE. Under the proposed scheme, an OFDM symbol may be split to 4 (or 8 or 16 or another number) segments, and the value of a-factor may be used to indicate at which segment the pre-FEC padding is ended.

Referring to FIG. 22, under Option-1, the value of a-factor may be used to indicate pre-FEC padding boundary/MAC boundary. The PHY boundary may be either at the end of the last OFDM symbol or in the middle of the last symbol with two segments for post-FEC padding. The PE may be either a fixed value or depending on a-factor or PHY boundary. In FIG. 22, “MAC boundary” may refer to pre-FEC padding boundary, and “PHY boundary” may refer to FEC coding boundary.

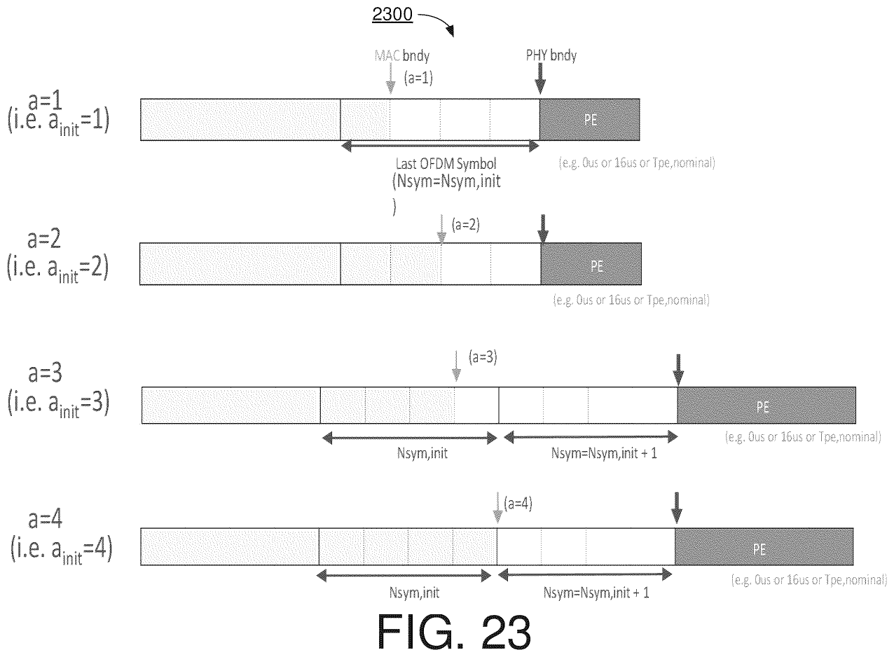

FIG. 23 illustrates an example scenario 2300 of rate matching in a third option (Option-2) under a proposed scheme in accordance with the present disclosure. Under the proposed scheme, MAC boundary and PHY boundary may be decoupled. That is, the PHY boundary may be always at the end of an OFDM symbol or at an OFDM symbol boundary. Additionally, the MAC boundary or pre-FEC padding boundary may be indicated by a-factor. Moreover, the definition of a-factor may be re-purposed to indicate aᵢₙᵢₜ instead of a-factor (e.g., the parameter a-factor may be used to indicate the pre-FEC padding boundary or MAC boundary). The value of aᵢₙᵢₜ or a-factor may be kept up to 4 (e.g., aᵢₙᵢₜ or a=1, 2, 3, 4) or other values (e.g., 1~8 or 1~16 or else). The PE may have a fixed value, independent of a-factor. The PHY boundary or FEC coding boundary may be determined by the value of aᵢₙᵢₜ. For instance, if aᵢₙᵢₜ=1 or 2, PHY boundary may be at the end of an OFDM symbol, with no post-FEC padding; and if aᵢₙᵢₜ=3 or 4, one extra OFDM symbol may be added, and PHY boundary may be at the end of the extra OFDM symbol. Under the proposed scheme, the meaning of the parameter of LDPC extra symbol segment may be re-purposed to indicate the PE duration or to indicate the addition of extra symbol(s). For instance, LDPC extra symbol segment=0 may indicate no extra OFDM symbol (or no PE), and LDPC extra symbol segment=1 may indicate the addition of one or more OFDM symbols with PE, and the PE duration may be either fixed or determined according to aᵢₙᵢₜ and nominal PE.

Referring to FIG. 23, under Option-2, the value of a-factor may be used to indicate pre-FEC padding boundary/MAC boundary. The PHY boundary may be at the end of the last OFDM symbol, with N_{sym}=N_{sym,init} or N_{sym}=N_{sym,init}+1, and with no post-FEC padding. The PE may always have a fixed value as T_{PE,nominal}, independent of a-factor. In FIG. 23, “MAC boundary” may refer to pre-FEC padding boundary, and “PHY boundary” may refer to FEC coding boundary.

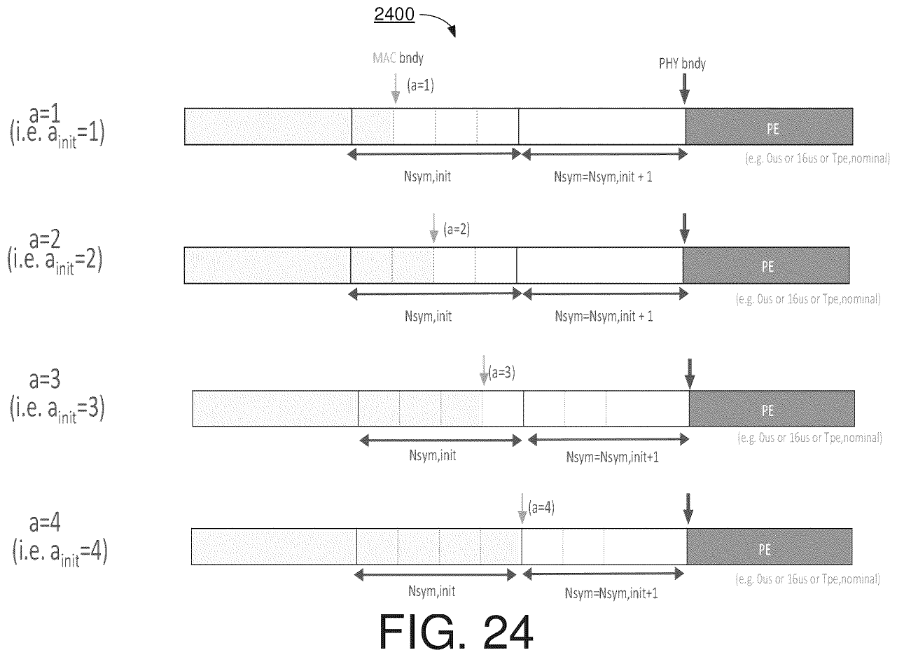

FIG. 24 illustrates an example scenario 2400 of rate matching in a fourth option (Option-3) under a proposed scheme in accordance with the present disclosure. Under the proposed scheme, MAC boundary and PHY boundary may be decoupled. That is, the PHY boundary may be always at the end of an OFDM symbol or at an OFDM symbol boundary. Additionally, the MAC boundary or pre-FEC padding boundary may be indicated by the parameter of a-factor. Moreover, the definition of a-factor may be re-purposed to indicate aᵢₙᵢₜ instead of a-factor (e.g., the parameter a-factor may be used to indicate the pre-FEC padding boundary or MAC boundary). The value of aᵢₙᵢₜ or a-factor may be kept up to 4 (e.g., aᵢₙᵢₜ or a=1, 2, 3, 4) or other values (e.g., 1~8 or 1~16 or else). Under the proposed scheme, one or more extra OFDM symbols may be added. The PHY boundary or FEC coding boundary may be at the end of the last OFDM symbol boundary, with no post-FEC padding. The PE may have a fixed value, independent of a-factor. Under the proposed scheme, the meaning of the parameter of LDPC extra symbol segment may be re-purposed to indicate the PE duration or to indicate the addition of extra symbol(s). For instance, LDPC extra symbol segment=0 may indicate no extra OFDM symbol (or no PE), and LDPC extra symbol segment=1 may indicate the addition of one or more OFDM symbols with PE, and the PE duration may be either fixed or determined according to aᵢₙᵢₜ and nominal PE.

Referring to FIG. 24, under Option-3, the value of a-factor may be used to indicate pre-FEC padding boundary/MAC boundary. The PHY boundary may be at the end of the last OFDM symbol, with N_{sym}=N_{sym,init}+1, and with no post-FEC padding. The PE may always have a fixed value as T_{PE,nominal}, independent of a-factor. In FIG. 24, “MAC boundary” may refer to pre-FEC padding boundary, and “PHY boundary” may refer to FEC coding boundary.

In a fifth option (Option-4) under a proposed scheme in accordance with the present disclosure with respect to rate matching design, the value of the LDPC extra symbol segment parameter may always be forced to 1. Moreover, the value of a-factor may be kept up to 4 (e.g., a=1, 2, 3, 4). All other parameters may be kept the same without change. The PE may be dependent on a-factor and T_{PE,nominal}.

### Illustrative Implementations

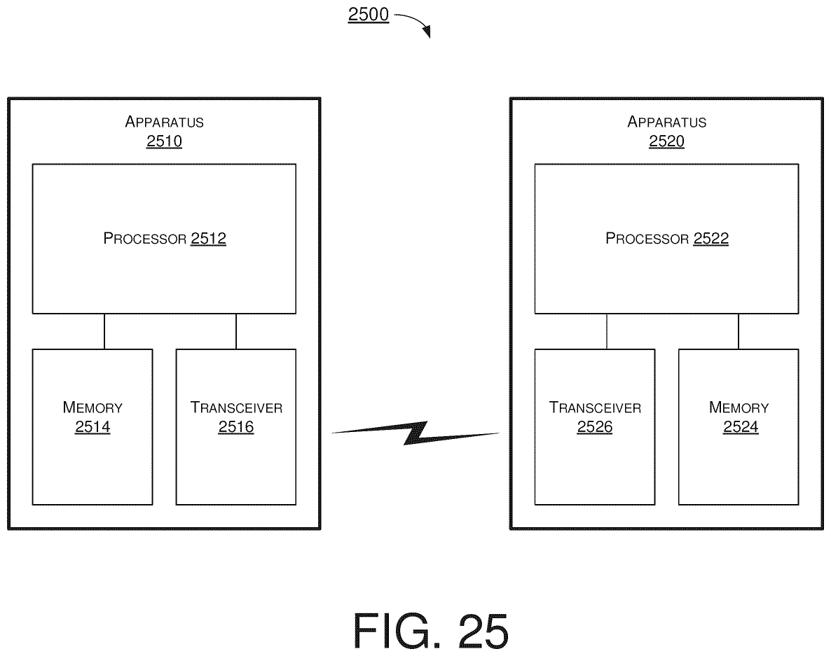

FIG. 25 illustrates an example system 2500 having at least an example apparatus 2510 and an example apparatus 2520 in accordance with an implementation of the present disclosure. Each of apparatus 2510 and apparatus 2520 may perform various functions to implement schemes, techniques, processes and methods described herein pertaining to LDPC optimization for short-packet transmission for next-generation WLAN systems in wireless communications including the various schemes described above with respect to various proposed designs, concepts, schemes, systems and methods described above as well as processes described below. For instance, apparatus 2510 may be implemented in STA 110 and apparatus 2520 may be implemented in STA 120, or vice versa.

Each of apparatus 2510 and apparatus 2520 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 2510 and apparatus 2520 may be implemented in a smartphone, a smart watch, a personal digital assistant, a digital camera, or a computing equipment such as a tablet computer, a laptop computer or a notebook computer. Each of apparatus 2510 and apparatus 2520 may also be a part of a machine type apparatus, which may be an IoT apparatus such as an immobile or a stationary apparatus, a home apparatus, a wire communication apparatus or a computing apparatus. For instance, each of apparatus 2510 and apparatus 2520 may be implemented in a smart thermostat, a smart fridge, a smart door lock, a wireless speaker or a home control center. When implemented in or as a network apparatus, apparatus 2510 and/or apparatus 2520 may be implemented in a network node, such as an AP in a WLAN.

In some implementations, each of apparatus 2510 and apparatus 2520 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 2510 and apparatus 2520 may be implemented in or as a STA or an AP. Each of apparatus 2510 and apparatus 2520 may include at least some of those components shown in FIG. 25 such as a processor 2512 and a processor 2522, respectively, for example. Each of apparatus 2510 and apparatus 2520 may further include one or more other components not pertinent to the proposed scheme of the present disclosure (e.g., internal power supply, display device and/or user interface device), and, thus, such component(s) of apparatus 2510 and apparatus 2520 are neither shown in FIG. 25 nor described below in the interest of simplicity and brevity.

In one aspect, each of processor 2512 and processor 2522 may be implemented in the form of one or more single-core processors, one or more multi-core processors, one or more RISC processors or one or more CISC processors. That is, even though a singular term “a processor” is used herein to refer to processor 2512 and processor 2522, each of processor 2512 and processor 2522 may include multiple processors in some implementations and a single processor in other implementations in accordance with the present disclosure. In another aspect, each of processor 2512 and processor 2522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 2512 and processor 2522 is a special-purpose machine specifically designed, arranged and configured to perform specific tasks including those pertaining to LDPC optimization for short-packet transmission for next-generation WLAN systems in wireless communications in accordance with various implementations of the present disclosure.

In some implementations, apparatus 2510 may also include a transceiver 2516 coupled to processor 2512. Transceiver 2516 may include a transmitter capable of wirelessly transmitting and a receiver capable of wirelessly receiving data. In some implementations, apparatus 2520 may also include a transceiver 2526 coupled to processor 2522. Transceiver 2526 may include a transmitter capable of wirelessly transmitting and a receiver capable of wirelessly receiving data. It is noteworthy that, although transceiver 2516 and transceiver 2526 are illustrated as being external to and separate from processor 2512 and processor 2522, respectively, in some implementations, transceiver 2516 may be an integral part of processor 2512 as a system on chip (SoC), and transceiver 2526 may be an integral part of processor 2522 as a SoC.

In some implementations, apparatus 2510 may further include a memory 2514 coupled to processor 2512 and capable of being accessed by processor 2512 and storing data therein. In some implementations, apparatus 2520 may further include a memory 2524 coupled to processor 2522 and capable of being accessed by processor 2522 and storing data therein. Each of memory 2514 and memory 2524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 2514 and memory 2524 may include a type of read-only memory (ROM) such as mask ROM, programmable ROM (PROM), erasable programmable ROM (EPROM) and/or electrically erasable programmable ROM (EEPROM). Alternatively, or additionally, each of memory 2514 and memory 2524 may include a type of non-volatile random-access memory (NVRAM) such as flash memory, solid-state memory, ferroelectric RAM (FeRAM), magnetoresistive RAM (MRAM) and/or phase-change memory.

Each of apparatus 2510 and apparatus 2520 may be a communication entity capable of communicating with each other using various proposed schemes in accordance with the present disclosure. For illustrative purposes and without limitation, a description of capabilities of apparatus 2510, as STA 110, and apparatus 2520, as STA 120, is provided below in the context of example process 2600. It is noteworthy that, although a detailed description of capabilities, functionalities and/or technical features of apparatus 2520 is provided below, the same may be applied to apparatus 2510 although a detailed description thereof is not provided solely in the interest of brevity. It is also noteworthy that, although the example implementations described below are provided in the context of WLAN, the same may be implemented in other types of networks.

### Illustrative Processes

FIG. 26 illustrates an example process 2600 in accordance with an implementation of the present disclosure. Process 2600 may represent an aspect of implementing various proposed designs, concepts, schemes, systems and methods described above. More specifically, process 2600 may represent an aspect of the proposed concepts and schemes pertaining to LDPC optimization for short-packet transmission for next-generation WLAN systems in wireless communications in accordance with the present disclosure. Process 2600 may include one or more operations, actions, or functions as illustrated by one or more of blocks 2610 and 2620. Although illustrated as discrete blocks, various blocks of process 2600 may be divided into additional blocks, combined into fewer blocks, or eliminated, depending on the desired implementation. Moreover, the blocks/sub-blocks of process 2600 may be executed in the order shown in FIG. 26 or, alternatively, in a different order. Furthermore, one or more of the blocks/sub-blocks of process 2600 may be executed repeatedly or iteratively. Process 2600 may be implemented by or in apparatus 2510 and apparatus 2520 as well as any variations thereof. Solely for illustrative purposes and without limiting the scope, process 2600 is described below in the context of apparatus 2510 implemented in or as STA 110 functioning as a non-AP STA or an AP STA and apparatus 2520 implemented in or as STA 120 functioning as an AP STA or a non-AP STA of a wireless network such as a WLAN in network environment 100 in accordance with one or more of IEEE 802.11 standards. Process 2600 may begin at block 2610.

At 2610, process 2600 may involve processor 2512 of apparatus 2510 performing LDPC encoding on a plurality of bits of a short packet of less than 1000 bytes with at least one LDPC enhancement. Process 2600 may proceed from 2610 to 2620.

At 2620, process 2600 may involve processor 2512 transmitting, via transceiver 2516, the short packet in a wireless communication system (e.g., to apparatus 2520).

In some implementations, the LDPC enhancement may involve forcing a value of an LDPC extra symbol segment parameter to be a predetermined value. For instance, the value of the LDPC extra symbol segment parameter may be set to 1.

In some implementations, the LDPC enhancement may involve forcing a value of a pre-FEC padding factor, or a-factor, to be a predetermined value. For instance, the value of the a-factor may be set to 4.

In some implementations, the LDPC enhancement may involve an adjustment to a pre-FEC padding factor, or a-factor. For instance, the adjustment to the a-factor may involve adjusting the a-factor to cross a last symbol boundary when an initial value of the a-factor=3 or 4.

In some implementations, the LDPC enhancement may involve an adjustment to an MCS for a same airtime. For instance, the adjustment to the MCS may involve selecting a lower MCS during the LDPC encoding, with the lower MCS being lower than an initial MCS pre-selected based on a channel condition for a given RU size and a given number of spatial streams (Nₛₛ).

In some implementations, the LDPC enhancement may involve adding one or more extra symbol segments or adding one or more extra OFDM symbols.

In some implementations, the LDPC enhancement may involve performing rate matching under one of a plurality of options to enhance LDPC performance.

Under a first option (e.g., Option-0 described above) of the plurality of options of rate matching, process 2600 may involve processor 2512 performing the following: (1) forcing a value of an LDPC extra symbol segment parameter to 1; (2) keeping a pre-FEC padding boundary at a position of a−1, with a denoting a pre-FEC padding factor, or a-factor; (3) keeping a PHY boundary at an end of a last OFDM symbol of the short packet, with no post-FEC padding; and (4) keeping a value of PE at a fixed value, independent of the a-factor.

Under a second option (e.g., Option-1 described above) of the plurality of options of rate matching, process 2600 may involve processor 2512 performing the following: (1) using a value of a pre-FEC padding factor, or a-factor, to indicate a pre-FEC padding boundary; (2) keeping a PHY boundary at an end of a last OFDM symbol of the short packet or in a middle of a last symbol with two segments for post-FEC padding; and (3) keeping a value of PE at a fixed value or dependent on the a-factor.

Under a third option (e.g., Option-2 described above) of the plurality of options of rate matching, process 2600 may involve processor 2512 performing the following: (1) using a value of a pre-FEC padding factor, or a-factor, to indicate a pre-FEC padding boundary; (2) keeping a PHY boundary at an end of a last OFDM symbol of the short packet, with no post-FEC padding; (3) keeping a number of symbols (N_{sym}) equal to an initial number of symbols (N_{sym,init}) or N_{sym,init}+1; and (4) keeping a value of PE at a fixed value, independent of the a-factor.

Under a fourth option (e.g., Option-3 described above) of the plurality of options of rate matching, process 2600 may involve processor 2512 performing the following: (1) using a value of a pre-FEC padding factor, or a-factor, to indicate a pre-FEC padding boundary; (2) keeping a PHY boundary at an end of a last OFDM symbol of the short packet, with no post-FEC padding; (3) keeping a number of symbols (N_{sym}) equal to an initial number of symbols (N_{sym,init})+1; and (4) keeping a value of PE at a fixed value, independent of the a-factor.

Under a fifth option (e.g., Option-4 described above) of the plurality of options of rate matching, process 2600 may involve processor 2512 performing the following: (1) forcing a value of an LDPC extra symbol segment parameter to 1; (2) keeping a value of a pre-FEC padding factor, or a-factor, up to 4; and (3) adjusting a value of PE according to the a-factor and a nominal PE value.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, low-density parity-check (LDPC) encoding on a plurality of bits of a short packet of less than 1000 bytes with at least one LDPC enhancement; and
transmitting, by the processor, the short packet in a wireless communication system.

2. The method of claim 1, wherein the LDPC enhancement comprises forcing a value of an LDPC extra symbol segment parameter to be a predetermined value.

3. The method of claim 2, wherein the value of the LDPC extra symbol segment parameter is set to 1.

4. The method of claim 1, wherein the LDPC enhancement comprises forcing a value of a pre-forward error correction (pre-FEC) padding factor, or a-factor, to be a predetermined value.

5. The method of claim 4, wherein the value of the a-factor is set to 4.

6. The method of claim 1, wherein the LDPC enhancement comprises an adjustment to a pre-forward error correction (pre-FEC) padding factor, or a-factor.

7. The method of claim 6, wherein the adjustment to the a-factor comprises adjusting the a-factor to cross a last symbol boundary when an initial value of the a-factor=3 or 4.

8. The method of claim 1, wherein the LDPC enhancement comprises an adjustment to a modulation and coding scheme (MCS) for a same airtime.

9. The method of claim 8, wherein the adjustment to the MCS comprises selecting a lower MCS during the LDPC encoding, with the lower MCS being lower than an initial MCS pre-selected based on a channel condition for a given resource unit (RU) size and a given number of spatial streams (Nₛₛ).

10. The method of claim 1, wherein the LDPC enhancement comprises adding one or more extra symbol segments or adding one or more extra orthogonal frequency-division multiplexing (OFDM) symbols.

11. The method of claim 1, wherein the LDPC enhancement comprises performing rate matching under one of a plurality of options to enhance LDPC performance.

12. The method of claim 11, wherein the performing of rate matching under a first option of the plurality of options comprises:
forcing a value of an LDPC extra symbol segment parameter to 1;
keeping a pre-forward error correction (pre-FEC) padding boundary at a position of a−1, with a denoting a pre-FEC padding factor, or a-factor;
keeping a physical layer (PHY) boundary at an end of a last orthogonal frequency-division multiplexing (OFDM) symbol of the short packet, with no post-FEC padding; and
keeping a value of packet extension (PE) at a fixed value, independent of the a-factor.

13. The method of claim 11, wherein the performing of rate matching under a second option of the plurality of options comprises:
using a value of a pre-forward error correction (pre-FEC) padding factor, or a-factor, to indicate a pre-FEC padding boundary;
keeping a physical layer (PHY) boundary at an end of a last orthogonal frequency-division multiplexing (OFDM) symbol of the short packet or in a middle of a last symbol with two segments for post-FEC padding; and
keeping a value of packet extension (PE) at a fixed value or dependent on the a-factor.

14. The method of claim 11, wherein the performing of rate matching under a third option of the plurality of options comprises:
using a value of a pre-forward error correction (pre-FEC) padding factor, or a-factor, to indicate a pre-FEC padding boundary;
keeping a physical layer (PHY) boundary at an end of a last orthogonal frequency-division multiplexing (OFDM) symbol of the short packet, with no post-FEC padding;
keeping a number of symbols (N_{sym}) equal to an initial number of symbols (N_{sym,init}) or N_{sym,init}+1; and
keeping a value of packet extension (PE) at a fixed value, independent of the a-factor.

15. The method of claim 11, wherein the performing of rate matching under a fourth option of the plurality of options comprises:
using a value of a pre-forward error correction (pre-FEC) padding factor, or a-factor, to indicate a pre-FEC padding boundary;
keeping a physical layer (PHY) boundary at an end of a last orthogonal frequency-division multiplexing (OFDM) symbol of the short packet, with no post-FEC padding;
keeping a number of symbols (N_{sym}) equal to an initial number of symbols (N_{sym,init})+1; and
keeping a value of packet extension (PE) at a fixed value, independent of the a-factor.

16. The method of claim 11, wherein the performing of rate matching under a fifth option of the plurality of options comprises:
forcing a value of an LDPC extra symbol segment parameter to 1;
keeping a value of a pre-forward error correction (pre-FEC) padding factor, or a-factor, up to 4; and
adjusting a value of packet extension (PE) according to the a-factor and a nominal PE value.

17. An apparatus, comprising:
a transceiver configured to communicate wirelessly; and
a processor coupled to the transceiver and configured to perform operations comprising:
performing low-density parity-check (LDPC) encoding on a plurality of bits of a short packet of less than 1000 bytes with at least one LDPC enhancement; and
transmitting, via the transceiver, the short packet in a wireless communication system.

18. The apparatus of claim 17, wherein the LDPC enhancement comprises forcing a value of an LDPC extra symbol segment parameter to be 1.

19. The apparatus of claim 17, wherein the LDPC enhancement comprises forcing a value of a pre-forward error correction (pre-FEC) padding factor, or a-factor, to be 4.

20. The apparatus of claim 17, wherein the LDPC enhancement comprises performing rate matching under one of a plurality of options to enhance LDPC performance.
